(19) United States
(12) Patent Application Publication
(10) Pub. No.: US 2024/0288629 A1
(43) Pub. Date: Aug. 29, 2024

(54) OPTICAL FIBER AND OPTICAL FIBER RIBBON

(71) Applicant: SUMITOMO ELECTRIC INDUSTRIES, LTD., Osaka (JP)

(72) Inventors: Noriaki IWAGUCHI, Osaka (JP); Katsushi HAMAKUBO, Osaka (JP); Miho IKEGAWA, Osaka (JP)

(21) Appl. No.: 18/585,181

(22) Filed: Feb. 23, 2024

(30) Foreign Application Priority Data
Feb. 27, 2023 (JP) 2023-028081

(51) Int. Cl. G02B 6/02; C03C 25/105; G02B 6/44

(52) U.S. Cl. CPC G02B 6/02395; C03C 25/105; G02B 6/4403; C03C 2217/445; C03C 2217/477

(57) ABSTRACT

An optical fiber according to the present disclosure includes a glass fiber including a core and a cladding, and a first resin layer covering the glass fiber so as to be in contact with the glass fiber. The first resin layer includes a cured product of a resin composition containing a photopolymerizable compound, a photopolymerization initiator, and titanium oxide particles, and a content of the titanium oxide particles is 0.1% by mass to 10% by mass based on a total amount of the resin composition.

### CROSS-REFERENCE TO RELATED APPLICATIONS

This application claims priority based on Japanese Patent Application No. 2023-028081 filed on Feb. 27, 2023, and the entire contents of the Japanese patent application are incorporated herein by reference.

### TECHNICAL FIELD

The present disclosure relates to an optical fiber and an optical fiber ribbon.

### BACKGROUND

In general, an optical fiber includes a coating resin layer for protecting a glass fiber which transmits optical signals. The coating resin layer has, for example, a primary resin layer in contact with the glass fiber and a secondary resin layer formed on the outer peripheral surface of the primary resin layer, and the outermost layer of the coating resin layer is constituted by a colored resin layer for identifying the optical fiber (for example, refer to, JP 1994-242355 A and WO 2016-047002 A1).

### SUMMARY

An optical fiber according to one aspect of the present disclosure includes, a glass fiber including a core and a cladding, and a first resin layer covering the glass fiber so as to be in contact with the glass fiber. The first resin layer includes a cured product of a resin composition containing a photopolymerizable compound, a photopolymerization initiator, and titanium oxide particles, and a content of the titanium oxide particles is 0.1% by mass to 10% by mass based on a total amount of the resin composition.

### BRIEF DESCRIPTION OF THE DRAWINGS

FIG. 1 is a schematic cross-sectional view showing an example of an optical fiber according to an embodiment.

FIG. 2 is a schematic cross-sectional view showing another example of an optical fiber according to an embodiment.

FIG. 3 is a schematic cross-sectional view showing an example of an optical fiber ribbon according to an embodiment.

### DETAILED DESCRIPTION

In recent years, in data center applications, there has been an increasing demand for high-density cables with an increased packing density of optical fibers. As the packing density of optical fibers in a cable increases, it is advantageous to reduce the outer diameters of the optical fibers. In order to reduce the outer diameter of the optical fiber, it is conceivable to reduce the thickness of the coating resin layer and the colored resin layer, but this may make it difficult to identify the optical fiber. Therefore, an object of the present disclosure is to provide an optical fiber and an optical fiber ribbon having excellent identifiability.

### DESCRIPTION OF EMBODIMENTS OF PRESENT DISCLOSURE

First, the contents of embodiments of the present disclosure will be listed and explained.

(1) An optical fiber according to an embodiment of the present disclosure includes, a glass fiber including a core and a cladding, and a first resin layer covering the glass fiber so as to be in contact with the glass fiber. The first resin layer includes a cured product of a resin composition containing a photopolymerizable compound, a photopolymerization initiator, and titanium oxide particles, and a content of the titanium oxide particles is 0.1% by mass to 10% by mass based on a total amount of the resin composition.

The optical fiber according to the present disclosure can be improved in identifiability of the optical fiber by containing a specific amount of titanium oxide particles in the resin layer directly covering the glass fiber.

(2) According to the above (1), the titanium oxide particles may be surface-treated titanium oxide particles from the viewpoint of enhancing dispersibility in the resin layer.

(3) According to the above (2), the surface-treated titanium oxide particles may have a surface treatment layer containing at least one selected from the group consisting of aluminum oxide, silicon dioxide, and zirconium dioxide from the viewpoint of improving the weather resistance of the resin layer.

(4) According to the above (3), the surface treatment layer may contain aluminum oxide, and a content of the aluminum oxide in the surface-treated titanium oxide particles may be 1% by mass to 6% by mass from the viewpoint of further improving the identifiability of the optical fiber.

(5) According to any one of the above (1) to (4), the photopolymerizable compound may include an epoxy di(meth)acrylate having a bisphenol skeleton and an alkylene oxide-modified di(meth)acrylate having a bisphenol skeleton from the viewpoint of adjusting the Young's modulus of the resin layer.

(6) According to any one of the above (1) to (5), the photopolymerization initiator may include an α-hydroxyacetophenone compound from the viewpoint of the curability of the resin layer.

(7) According to any one of the above (1) to (6), the optical fiber may have an outer diameter of 150 μm to 190 μm from the viewpoint of densification of the optical cable.

(8) According to any one of the above (1) to (6), the glass fiber may include a plurality of the cores from the viewpoint of densification of the optical cable.

(9) An optical fiber ribbon according to an embodiment of the present disclosure includes a plurality of the optical fibers according to any one of (1) to (8) arranged in parallel, and a connecting resin layer coating and connecting the plurality of the optical fibers. Thus, an optical fiber ribbon including optical fibers having excellent identifiability can be provided.

### Details of Embodiments of Present Disclosure

Specific examples of an optical fiber and an optical fiber ribbon according to the embodiments of the present disclosure will be described with reference to the drawings as necessary. The present disclosure is not limited to these examples, but is defined by the claims, and is intended to include all modifications within the meaning and scope equivalent to the claims. In the following description, the same elements are denoted by the same reference numerals in the description of the drawings, and redundant description will be omitted. In the embodiments of the present disclosure, a (meth)acrylate means an acrylate or a meth acrylate corresponding thereto, and other similar expressions such as (meth)acrylic acid are in the same way.

### (Optical Fiber)

An optical fiber according to an embodiment includes a glass fiber including a core and a cladding, and a first resin layer that is in contact with the glass fiber and covers the glass fiber. The first resin layer has a single-layer structure. That is, the coating resin layer of the optical fiber according to the embodiment is configured only by the first resin layer.

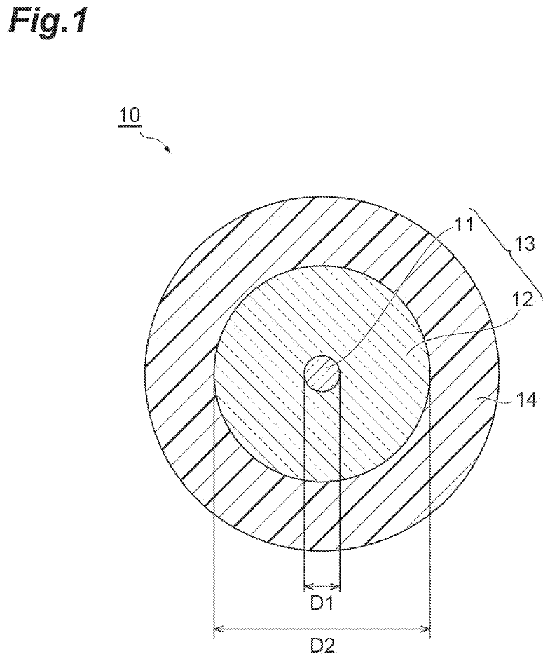

FIG. 1 is a schematic cross-sectional view showing an example of an optical fiber according to the embodiment. An optical fiber 10 includes a glass fiber 13 including a core 11 and a cladding 12, and a first resin layer 14 provided on the outer peripheral surface of glass fiber 13.

Cladding 12 surrounds core 11. Core 11 and cladding 12 mainly contain glass such as quartz glass, and for example, germanium-doped quartz glass or pure quartz glass can be used for core 11, and pure quartz glass or fluorine-doped quartz glass can be used for cladding 12.

In FIG. 1, for example, an outer diameter (D2) of glass fiber 13 may be 100 μm to 125 μm, and a diameter (D1) of core 11 included in glass fiber 13 may be 7 μm to 15 μm. A thickness of first resin layer 14 may be 10 μm to 50 μm, 15 μm to 40 μm, or 20 μm to 30 μm. An outer diameter of optical fiber 10 may be 150 μm to 220 μm, 150 μm to 200 μm, or 150 μm to 190 μm, from the viewpoint of densification of the optical cable.

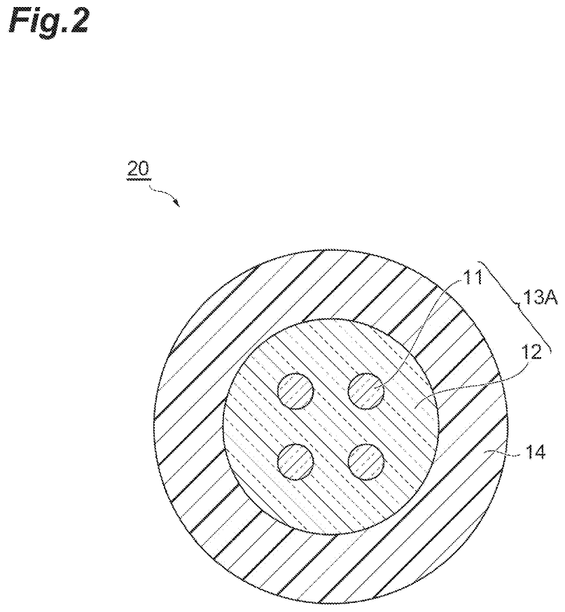

Although FIG. 1 shows an optical fiber including a glass fiber having one core, the optical fiber according to the embodiment may be an optical fiber including a glass fiber having a plurality of cores (hereinafter, also referred to as a “multi-core optical fiber”). The multi-core optical fiber is an optical fiber in which a plurality of cores extending in a fiber axial direction are covered with a common cladding. In the multi-core optical fiber, the materials of the plurality of cores may be the same or different. As an example of the multi-core optical fiber, FIG. 2 shows an optical fiber 20 including a glass fiber 13A having four cores 11.

An outer diameter of glass fiber 13A may be 125 μm to 220 μm, 150 μm to 210 μm, or 170 μm to 190 μm. An outer diameter of optical fiber 20 may be 200 μm to 220 μm, 220 μm to 240 μm, or 230 μm to 250 μm. When the outer diameter of the glass fiber is increased, it is difficult to form a coating resin layer having a uniform thickness. However, first resin layer 14 according to the embodiment includes a cured product of a specific resin composition, and thus the thickness is likely to be uniform.

The first resin layer includes a cured product of a resin composition containing a photopolymerizable compound, a photopolymerization initiator, and titanium oxide particles. The resin composition according to the embodiment is a UV-curable resin composition. The content of the titanium oxide particles may be 0.1% by mass to 10% by mass based on the total amount (100% by mass) of the resin composition.

The resin composition according to the embodiment contains titanium oxide particles, and thus the first resin layer is colored, and the identifiability of the optical fiber can be improved. As the titanium oxide particles, surface-treated titanium oxide particles may be used because of their excellent dispersibility in the resin composition. The surface-treated titanium oxide particles are particles of titanium oxide subjected to a surface treatment with an inorganic substance.

Examples of the inorganic substance used for the surface treatment include aluminum oxide, silicon dioxide, and zirconium dioxide. The surface-treated titanium oxide particle has a surface treatment layer containing at least one selected from the group consisting of aluminum oxide, silicon dioxide, and zirconium dioxide, and thus the dispersibility can be further improved. The surface treatment layer may be formed on at least a portion of the surface of the titanium oxide particle, or may be formed on the entire surface of the titanium oxide particle. The surface treatment layer is formed by surface treatment of the titanium oxide particle.

An amount of the surface treatment layer in the surface-treated titanium oxide particle may be 1% by mass or more, 1.5% by mass or more, or 2% by mass or more from the viewpoint of further improving dispersibility, and may be 10% by mass or less, 9% by mass or less, or 8% by mass or less from the viewpoint of enhancing hiding power. The amount of the surface treatment layer can be calculated by measuring the amounts of the titanium element and the inorganic elements other than titanium contained in the surface-treated titanium oxide particle by using inductively coupled mass spectrometry (ICP-MS). The surface treatment layer may contain aluminum oxide, and the content of aluminum oxide in the surface-treated titanium oxide particles may be 1% by mass to 6% by mass, 1.5% by mass to 5% by mass, or 2% by mass to 4% by mass from the viewpoint of further improving the identifiability of the optical fiber.

An average primary particle diameter of the surface-treated titanium oxide particles may be 300 nm or less, 295 nm or less, or 290 nm or less, from the viewpoint of improving the lateral pressure resistance of the first resin layer. The average primary particle diameter of the surface-treated titanium oxide particles may be 100 nm or more, 150 nm or more, or 200 nm or more, and 200 nm to 300 nm, from the viewpoint of enhancing the hiding power. The average primary particle diameter can be determined by, for example, image analysis of an electron micrograph, a light scattering method, a BET method, or the like.

The content of the surface-treated titanium oxide particles may be 0.2% by mass or more, 0.3% by mass or more, 0.4% by mass or more, or 0.5% by mass or more based on the total amount of the resin composition, from the viewpoint of improving the shielding property. The content of the surface-treated titanium oxide particles may be 8% by mass or less, 6% by mass or less, 4% by mass or less, or 3% by mass or less based on the total amount of the resin composition, from the viewpoint of enhancing the curability of the resin composition. The content of the surface-treated titanium oxide particles may be 0.2% by mass to 8% by mass, 0.3% by mass to 6% by mass, 0.4% by mass to 4% by mass, or 0.5% by mass to 3% by mass based on the total amount of the first resin layer, from the viewpoint of further improving the identifiability of the optical fiber.

The photopolymerizable compound may include an alkylene oxide-modified di(meth)acrylate having a bisphenol skeleton (hereinafter, also referred to as “alkylene oxide-modified di(meth)acrylate”) from the viewpoint of the curability of the resin composition.

The alkylene oxide-modified di(meth)acrylate may have at least one selected from the group consisting of an ethylene oxide (EO) chain and a propylene oxide (PO) chain from the viewpoint of adjusting Young's modulus. The ethylene oxide chain can be represented by “(EO) n”, and the propylene oxide chain can be represented by “(PO) n”. The “n” is an integer of 1 or more, may be 2 or more or 3 or more, and may be 40 or less, 35 or less, or 30 or less.

The alkylene oxide-modified di(meth)acrylate may have a bisphenol A skeleton from the viewpoint of the degree of cure. Examples of the alkylene oxide-modified di(meth)acrylate having a bisphenol A skeleton include EO-modified di(meth)acrylate of bisphenol A, PO-modified di(meth)acrylate of bisphenol A, and EO/PO-modified di(meth)acrylate of bisphenol A. The alkylene oxide-modified di(meth)acrylate may include EO modified di(meth)acrylate of bisphenol A.

The content of the alkylene oxide-modified di(meth)acrylate may be 25% by mass to 85% by mass, 30% by mass to 80% by mass, or 30% by mass to 75% by mass based on the total amount of the resin composition, from the viewpoint of the curability of the resin composition.

The photopolymerizable compound may include an epoxy di(meth)acrylate having a bisphenol skeleton (hereinafter, also referred to as “epoxy di(meth)acrylate”) from the viewpoint of adjusting Young's modulus. As the epoxy di(meth)acrylate, a reaction product of a diglycidyl ether compound having a bisphenol skeleton and a compound having a (meth)acryloyl group such as (meth)acrylic acid can be used.

Examples of the epoxy di(meth)acrylate include a (meth)acrylic acid adduct of bisphenol A-diglycidyl ether, a (meth)acrylic acid adduct of bisphenol AF-diglycidyl ether, and a (meth)acrylic acid adduct of bisphenol F-diglycidyl ether.

The content of the epoxy di(meth)acrylate may be 10% by mass to 70% by mass, 20% by mass to 60% by mass, or 30% by mass to 50% by mass based on the total amount of the resin composition, from the viewpoint of increasing the strength of the resin layer.

It is better for the photopolymerizable compound not to include a urethane (meth)acrylate from the viewpoint of curability of the resin composition. When the urethane (meth)acrylate is included, the content may be 20% by mass or less, 15% by mass or less, 10% by mass or less, or 5% by mass or less based on the total amount of the resin composition.

The urethane (meth)acrylate may be a compound obtained by reacting a polyol compound, a polyisocyanate compound, and a hydroxyl group-containing (meth)acrylate. Examples of the polyol compound include polytetramethylene glycol, polypropylene glycol, and a bisphenol A-ethylene oxide adduct diol. From the viewpoint of adjusting the Young's modulus, a number average molecular weight (Mn) of the polyol compound may be 300 to 8000, 400 to 5000, or 500 to 4000. Examples of the polyisocyanate compound include 2,4-tolylene diisocyanate, 2,6-tolylene diisocyanate, isophorone diisocyanate, and dicyclohexylmethane 4,4′-diisocyanate. Examples of the hydroxyl group-containing (meth)acrylate includes, 2-hydroxyethyl (meth)acrylate, 2-hydroxybutyl (meth)acrylate, 1,6-hexanediol mono(meth)acrylate, pentaerythritol tri(meth)acrylate, 2-hydroxypropyl (meth)acrylate, and tripropylene glycol (meth)acrylate.

An organotin compound is generally used as a catalyst for synthesizing the urethane (meth)acrylate. Examples of the organotin compound include dibutyltin dilaurate, dibutyltin diacetate, dibutyltin maleate, dibutyltin bis(2-ethylhexyl mercaptoacetate), dibutyltin bis(isooctyl mercaptoacetate), and dibutyltin oxide. From the viewpoint of availability or catalyst performance, for example, dibutyltin dilaurate or dibutyltin diacetate may be used as the organotin compound.

Lower alcohol having 5 or less carbon atoms may be used in the synthesis of the urethane (meth)acrylate. Examples of the lower alcohol include methanol, ethanol, 1-propanol, 2-propanol, 1-butanol, 2-butanol, 2-methyl-2-propanol, 1-pentanol, 2-pentanol, 3-pentanol, 2-methyl-1-butanol, 3-methyl-1-butanol, 2-methyl-2-butanol, 3-methyl-2-butanol, and 2,2-dimethyl-1-propanol.

The photopolymerizable compound may further contain a photopolymerizable compound (hereinafter, also referred to as a “monomer”) other than an alkylene oxide-modified di(meth)acrylate, an epoxy di(meth)acrylate, and a urethane (meth)acrylate. As the monomer, for example, a monofunctional monomer having one polymerizable group or a polyfunctional monomer having two or more polymerizable groups can be used. The monomers may be used alone or in combination of two or more kinds thereof.

Examples of the monofunctional monomer include methyl (meth)acrylate-based monomers such as methyl (meth)acrylate, ethyl (meth)acrylate, propyl (meth)acrylate, n-butyl (meth)acrylate, s-butyl (meth)acrylate, tert-butyl (meth)acrylate, isobutyl (meth)acrylate, n-pentyl (meth)acrylate, isopentyl (meth)acrylate, hexyl (meth)acrylate, heptyl (meth)acrylate, isoamyl (meth)acrylate, 2-ethylhexyl (meth)acrylate, n-octyl (meth)acrylate, isooctyl (meth)acrylate, isodecyl (meth)acrylate, lauryl (meth)acrylate, 2-phenoxyethyl (meth)acrylate, 3-phenoxybenzyl acrylate, phenoxydiethylene glycol acrylate, phenoxy polyethylene glycol acrylate, 4-tert-butylcyclohexanol acrylate, tetrahydrofurfuryl (meth)acrylate, benzyl (meth)acrylate, dicyclopentenyl (meth)acrylate, dicyclopentenyloxyethyl (meth)acrylate, dicyclopentanyl (meth)acrylate, nonylphenol polyethylene glycol (meth)acrylate, nonylphenol ethylene oxide-modified (meth)acrylate, nonylphenoxypolyethylene glycol (meth)acrylate, isobornyl (meth)acrylate; carboxyl group-containing monomers such as (meth) acrylic acid, (meth) acrylic acid dimers, carboxyethyl (meth)acrylate, carbopentyl (meth)acrylate, ω-carboxy-polycaprolactone (meth)acrylate; heterocycle-containing (meth)acrylate such as N-acryloyl morpholine, N-vinyl pyrrolidone, N-vinylcaprolactam, N-acryloylpiperidine, N-methacryloylpiperidine, N-acryloylpyrrolidine, 3-(3-pyridyl) propyl (meth)acrylate, cyclic trimethylolpropane formal acrylate; maleimide-based monomers such as maleimide, N-cyclohexylmaleimide, N-phenylmaleimide; N-substituted amide-based monomers such as (meth)acrylamide, N,N-dimethyl(meth)acrylamide, N,N-diethyl(meth)acrylamide, N-hexyl(meth)acrylamide, N-N-ethyl(meth)acrylamide, N-methyl(meth)acrylamide, butyl(meth)acrylamide, N-methylol(meth)acrylamide, N-methylolpropane(meth)acrylamide; (meth)acrylic acid aminoalkyl-based monomers such as (meth)acrylic acid aminoethyl, (meth)acrylic acid aminopropyl, (meth)acrylic acid N,N-dimethylaminoethyl, (meth)acrylic acid tert-butylaminoethyl; succinimide-based monomers such as N-(meth)acryloyloxymethylene succinimide, N-(meth)acryloyl-6-oxyhexamethylene succinimide, N-(meth)acryloyl-8-oxyoctamethylene succinimide.

Examples of the polyfunctional monomer include ethylene glycol di(meth)acrylate, polyethylene glycol di(meth)acrylate, polypropylene glycol di(meth)acrylate, neopentyl glycol di(meth)acrylate, tripropylene glycol di(meth)acrylate, tetraethylene glycol di(meth)acrylate, hydroxypivalic acid neopentyl glycol di(meth)acrylate, 1,4-butanediol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-hexadecanediol di(meth)acrylate, 1,20-eicosanediol di(meth)acrylate, isopentyl di(meth)acrylate, 3-ethyl-1,8-octanediol di(meth)acrylate, trimethylolpropane tri(meth)acrylate, trimethyloloctane tri(meth)acrylate, trimethylolpropane polyethoxy tri(meth)acrylate, trimethylolpropane polypropoxy tri(meth)acrylate, trimethylolpropane polyethoxy polypropoxy tri(meth)acrylate, tris[(meth)acryloyloxyethyl] isocyanurate, pentaerythritol tri(meth)acrylate, pentaerythritol polyethoxy tetra(meth)acrylate, pentaerythritol polypropoxy tetra(meth)acrylate, pentaerythritol tetra(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, and caprolactone-modified tris[(meth)acryloyloxyethyl] isocyanurate.

The photopolymerization initiator can be appropriately selected from known radical photopolymerization initiators and used. The photopolymerization initiator may be used alone or as a mixture of two or more.

The photopolymerization initiator may include an α-hydroxyacetophenone compound from the viewpoint of enhancing the curability of the resin composition. Examples of the α-hydroxyacetophenone compound include 1-hydroxycyclohexyl phenyl ketone (Omnirad 184, produced by IGM Resins B.V.), 2-hydroxy-2-methyl-1-phenylpropanone (Omnirad 1173, produced by IGM Resins B.V.), 1-[4-(2-hydroxyethoxyl)-phenyl]-2-hydroxy-2-methylpropanone (Omnirad 2959, produced by IGM Resins B.V.), and 1-(4-isopropylphenyl)-2-hydroxy-2-methylpropan-1-one.

The content of the α-hydroxyacetophenone compound may be 0.5% by mass to 8.0% by mass, 1.0% by mass to 7.0% by mass, 2.0% by mass to 6.0% by mass, or 3.0% by mass to 5.0% by mass, based on the total amount of the resin composition.

The photopolymerization initiator may include a photopolymerization initiator other than the α-hydroxyacetophenone compound. Examples of such photopolymerization initiators include 2,2-dimethoxy-2-phenyl acetophenone, bis(2,6-dimethoxybenzoyl)-2,4,4-trimethylpentylphosphine oxide, 2-methyl-1-[4-(methylthio)phenyl]-2-morpholino-propan-1-one (Omnirad 907, produced by IGM Resins B.V.), 2,4 6-trimethylbenzoyldiphenylphosphine oxide (Omnirad TPO, produced by IGM Resins B.V.), and bis(2,4,6-trimethylbenzoyl)phenylphosphine oxide (Omnirad 819, produced by IGM Resins B.V.).

The content of the photopolymerization initiator may be 1% by mass to 10% by mass, 2% by mass to 9% by mass, 3% by mass to 8% by mass, 4% by mass to 7% by mass, or 5% by mass to 6% by mass based on the total amount of the resin composition.

The resin composition may further contain a silane coupling agent, a leveling agent, a antifoaming agent, an antioxidant, a sensitizer, and the like.

The silane coupling agent is not particularly limited as long as it does not hinder the curing of the resin composition. Examples of the silane coupling agent include tetramethyl silicate, tetraethyl silicate, mercaptopropyltrimethoxysilane, vinyltrichlorosilane, vinyltriethoxysilane, vinyltris(β-methoxy-ethoxy)silane, β-(3,4-epoxycyclohexyl)-ethyltrimethoxysilane, dimethoxydimethylsilane, diethoxydimethylsilane, 3-acryloxypropyltrimethoxysilane, 3-glycidoxypropyltrimethoxysilane, 3-glycidoxypropylmethyldiethoxysilane, 3-methacryloxypropyltrimethoxysilane, N-(β-aminoethyl)-γ-aminopropyltrimethoxysilane, N-(β-aminoethyl)-γ-aminopropyltrimethyldimethoxysilane, N-phenyl-3-aminopropyltrimethoxysilane, 3-chloropropyltrimethoxysilane, 3-mercaptopropyltrimethoxysilane, 3-aminopropyltrimethoxysilane, bis-[3-(triethoxysilyl)propyl]tetrasulfide, bis-[3-(triethoxysilyl)propyl]disulfide, γ-trimethoxysilylpropyldimethylthiocarbamyl tetrasulfide, and γ-trimethoxysilylpropylbenzothiazyl tetrasulfide.

From the viewpoints of the degree of cure and the coating removability, the Young's modulus of the first resin layer at 23° C. may be 1 MPa or more, and may be 600 MPa or less, 500 MPa or less, or 300 MPa or less. The Young's modulus can be determined from the 2.5% secant value obtained by performing a tensile test (gauge length: 25 mm) at 23° C. using a pipe-shaped coating resin layer (with a length of 50 mm or more) obtained by immersing an optical fiber in a solution (ethanol: acetone=3:7) and removing a glass fiber.

### (Optical Fiber Ribbon)

An optical fiber ribbon can be manufactured using the optical fiber according to the embodiment. The optical fiber ribbon according to the embodiment includes a plurality of optical fibers that are arranged in parallel, and a connecting resin layer connecting the plurality of optical fibers together so as to cover the plurality of optical fibers.

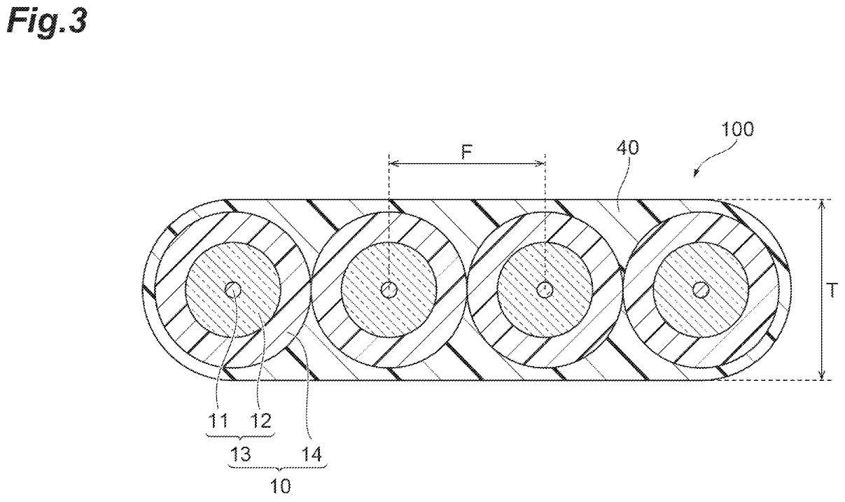

FIG. 3 is a schematic cross-sectional view of an example of an optical fiber ribbon according to an embodiment. In FIG. 3, an optical fiber ribbon 100 includes a plurality of optical fibers 10 arranged in parallel and a connecting resin layer 40 in which the plurality of optical fibers 10 are coated with a ribbon resin and connected to each other. In FIG. 3, four optical fibers 10 are shown as an example, but the number of optical fibers is not particularly limited.

Optical fibers 10 may be integrated in a state of being in contact with each other and being parallel to each other, or a part or all of optical fibers 10 may be integrated in a state of being parallel to each other at regular intervals. A center-to-center distance F between adjacent optical fibers 10 may be 220 μm to 280 μm. When the center-to-center distance is 220 μm to 280 μm, the optical fibers can be easily placed in the existing V-grooves, and an optical fiber ribbon having excellent batch fusion property can be obtained. A thickness T of optical fiber ribbon 100 may be 164 μm to 310 μm, although depending on the outer diameter of optical fiber 10. The ribbon resin is not particularly limited, and the connecting resin layer may include for example, a urethane (meth)acrylate or the like.

### EXAMPLES

The present disclosure will be described in more detail below by showing the results of evaluation tests using examples and comparative examples according to the present disclosure. It is noted that, the present invention is not limited to these examples.

As the titanium oxide particles, surface-treated titanium oxide particles having a surface treatment layer including aluminum oxide (Al₂O₃) shown in Table 1 below and titanium oxide particles which were not surface-treated were prepared. The amount of Al₂O₃ was calculated by quantifying the Ti element and the Al element contained in the surface-treated titanium oxide particles with a high-frequency inductively coupled plasma emission spectrometer (manufactured by Agilent Technologies, Inc., trade name “ICP-MS Agilent 7700x”).

TABLE 1

| | Ti-1 | Ti-2 | Ti-3 |
|---|---|---|---|
| Average primary particle diameter (nm) | 210 | 250 | 210 |
| Content of Al₂O₃ (mass %) | 2.0 | 4.0 | — |

### [Resin Composition for First Resin Layer]

### Test Example 1

A resin composition was prepared by mixing 35 parts by mass of bisphenol A-epoxy acrylate, 50 parts by mass of bisphenol A EO-modified diacrylate (EO number: 30), 10 parts by mass of tripropylene glycol diacrylate, 1 part by mass of 2,4,6-trimethylbenzoyldiphenylphosphine oxide (Omnirad TPO), and 4 parts by mass of 1-hydroxycyclohexyl phenyl ketone (Omnirad 184), and then mixing so that the content of titanium oxide particles (Ti-1) in the resin composition was 0.2% by mass.

### Test Example 2

A resin composition was prepared in the same manner as in Test Example 1, except that the titanium oxide particles (Ti-2) were mixed so that the content in the resin composition was 2.0% by mass.

### Test Example 3

A resin composition was prepared in the same manner as in Test Example 1, except that the content of the titanium oxide particles (Ti-1) was changed to 2.0% by mass.

### Test Example 4

A resin composition was prepared in the same manner as in Test Example 1, except that the titanium oxide particles (Ti-3) were mixed so that the content in the resin composition was 2.0% by mass.

### Test Example 5

A resin composition was prepared in the same manner as in Test Example 1, except that the titanium oxide particles were not mixed.

### [Production of Optical Fiber]

Each of the resin compositions of Test Example 1 to Test Example 5 were applied to the outer circumferential surface of a glass fiber having a diameter of 125 μm and constituted by a core and a cladding, and each resin composition was cured by irradiation with ultraviolet rays to form a first resin layer having a thickness of 27.5 μm, thereby producing an optical fiber having a diameter of 180 μm. Test example 1 to Test example 4 correspond to the examples, and Test example 5 corresponds to the comparative example.

### (Resin Composition for Ribbon)

A urethane acrylate a obtained by reacting 1 mol. of bisphenol A-ethylene oxide adduct diol, 2 mol. of tolylene diisocyanate, and 2 mol. of hydroxyethyl acrylate, and a urethane acrylate b obtained by reacting 1 mol. of polytetramethylene glycol, 2 mol. of tolylene diisocyanate, and 2 mol. of hydroxyethyl acrylate were prepared. A resin composition R was obtained by mixing 18 parts by mass of the urethane acrylate a, 10 parts by mass of the urethane acrylate b, 15 parts by mass of tricyclodecane diacrylate, 10 parts by mass of N-vinyl pyrrolidone, 10 parts by mass of isobornyl acrylate, 5 parts by mass of bisphenol A-ethylene oxide adduct diol diacrylate, 0.7 parts by mass of 2-methyl-1-[4-(methylthio)phenyl]-2-morpholino-propan-1-one (Omnirad 907), and 1.3 parts by mass of 2,4,6-trimethylbenzoyldiphenylphosphine oxide (Omnirad TPO).

### [Production of Optical Fiber Ribbon]

A 10 μm-thick connecting resin layer was formed around 12 optical fibers arranged in parallel using the resin composition R to produce an optical fiber ribbon.

### (Identifiability)

An aging test of the optical fiber ribbon was performed under an environment of a temperature of 85° C. and a humidity of 85%, and the identifiability was evaluated by confirming a change in color of the optical fibers. The case where the color (yellow and brown) of the optical fiber could be identified even after 90 days was evaluated as “A”, the case where the color of the optical fiber could be identified until 60 days was evaluated as “B”, and the case where the color of the optical fiber could be identified until 30 days was evaluated as “C”. It is noted that, the optical fiber of Test Example 5 was evaluated as “D” because the optical fiber did not contain titanium oxide particles and the resin layer was not colored, and thus the optical fiber could not be identified before the heat and humidity test. The results are shown in Table 2.

TABLE 2

| Test Example | | 1 | 2 | 3 | 4 | 5 |
|---|---|---|---|---|---|---|
| Titanium oxide | Type | Ti-1 | Ti-2 | Ti-1 | Ti-3 | — |
| particles | Content | 0.2 | 2.0 | 2.0 | 2.0 | — |
| | (mass %) | | | | | |

| | | | | | |
|---|---|---|---|---|---|
| Identifiability | A | A | B | C | D |

What is claimed is:

1. An optical fiber comprising:
a glass fiber including a core and a cladding; and
a first resin layer covering the glass fiber so as to be in contact with the glass fiber,
wherein the first resin layer includes a cured product of a resin composition containing a photopolymerizable compound, a photopolymerization initiator, and titanium oxide particles, and
a content of the titanium oxide particles is 0.1% by mass to 10% by mass based on a total amount of the resin composition.

2. The optical fiber according to claim 1, wherein the titanium oxide particles are surface-treated titanium oxide particles.

3. The optical fiber according to claim 2, wherein the surface-treated titanium oxide particles have a surface treatment layer containing at least one selected from the group consisting of aluminum oxide, silicon dioxide, and zirconium dioxide.

4. The optical fiber according to claim 3, wherein the surface treatment layer contains aluminum oxide, and a content of the aluminum oxide in the surface-treated titanium oxide particles is 1% by mass to 6% by mass.

5. The optical fiber according to claim 1, wherein the photopolymerizable compound includes an epoxy di(meth)acrylate having a bisphenol skeleton and an alkylene oxide-modified di(meth)acrylate having a bisphenol skeleton.

6. The optical fiber according to claim 1, wherein the photopolymerization initiator includes an α-hydroxyacetophenone compound.

7. The optical fiber according to claim 1, wherein the optical fiber has an outer diameter of 150 μm to 190 μm.

8. The optical fiber according to claim 1, wherein the glass fiber includes a plurality of the cores.

9. An optical fiber ribbon comprising:
a plurality of the optical fibers according to claim 1 arranged in parallel; and
a connecting resin layer for coating and connecting the plurality of the optical fibers.
